(19) United States
(12) Patent Application Publication
(10) Pub. No.: US 2023/0066035 A1
(43) Pub. Date: Mar. 2, 2023

(54) Facemask Dis-assembly Tool

(71) Applicant: Mandeep Singh, Kitchener (CA)

(72) Inventor: Mandeep Singh, Kitchener (CA)

(21) Appl. No.: 17/888,704

(22) Filed: Aug. 16, 2022

Related U.S. Application Data
(60) Provisional application No. 63/238,204, filed on Aug. 29, 2021.

(51) Int. Cl. B26F 1/14; A41H 43/00

(52) U.S. Cl. CPC B26F 1/14; A41H 43/00; B26F 2210/12

(57) ABSTRACT

Tool designed to dis-assemble face masks such that the mask fabric can be recycled. This tool separates mask materials such that the fabric and other components of the masks can be recycled. The tool has a punching element that pushes through the fabric of the mask and only removed the materials other than fabric from the mask. Mask can be simply be inserted in the tool for the separating operation. This tool can dis-assemble single or multiple masks in one operation cycle.

### BACKGROUND

Facemasks have been used in medical industry for long time and since the COVID-19 pandemic the facemasks are commonly used by general public to defend against air born microbes. Masks are being disposed in a large scale now and they are going into our landfills. Masks are made out of recyclable materials; they should not go to landfill. There is a need for a recycling system that can divert used masks from going into landfill. Face mask is made of various material like various grades of plastic, various types of metal, and various types of elastic, they all have to be separated so that they can be recycled properly.

### SUMMARY

The primary objective of the present invention is to separate nose strips from the fabric of face masks. Face mask fabric is generally made of polymer and the nose strip is generally made of metals such as aluminum. The fabric and nose strips can be recycled but they have to go through different recycling processes. For recycling the mask, it becomes important to separate the nose strip from the fabric.

The secondary objective of the present invention is to collect the separated nose strips and fabric into different bins for post processing.

The face mask dis-assembly tool is designed to receive the mask and separate the nose strip from the fabric in one operation. The tool consists of a base and a punch. The base is a fixed element, and the punch is a moving part that passes through the base. The mask is placed on the base from where it travels to a dis-assembly action position. This is where the punch cuts through the mask fabric and removes the nose strip. The punch works in a periodic way so that it can work on a continuous stream of face masks that are fed into the tool. The face masks can be fed as a manual feed or an automatic feed. The base of the tool where the mask is placed has an opening corresponding to the punch size with some clearance. The punch travels though this opening in a reciprocating fashion. The portion of the face mask that has the nose strip is placed on top of the opening in the base. The punch then advances towards the opening and cuts through the fabric. The punch then engages with the nose strip, pulls the nose strip out of the fabric completely and goes through the opening in the base. As the punch and the nose strip passes through the base, the nose strip springs open. Since the nose strip has sprung open it can not travel back with the punch. When the punch retracts, the nose strip interferes with the opposite side of the base and separates from the punch. This whole action separates the nose strip from the mask fabric. The nose strip is then channelled into a storage bin and the fabric is then channelled into a separate storage bin.

Further objects and advantages of this invention will be apparent from the following detailed description of the embodiment which is illustrated schematically in the accompanying drawings.

### BRIEF DESCRIPTION OF THE FIGURES

FIG. 1 shows the isometric view of the Facemask Dis-assembly Tool

FIG. 2 shows a face mask placed on the Facemask Dis-assembly Tool

FIG. 3 shows punch of Facemask Dis-assembly Tool cutting through the mask

FIG. 4 shows the nose strip being pulled out of the mask in the Facemask Dis-assembly Tool

FIG. 5 shows the complete separation of the nose strip from the mask in the Facemask Dis-assembly Tool.

### DETAIL EXPLANATION

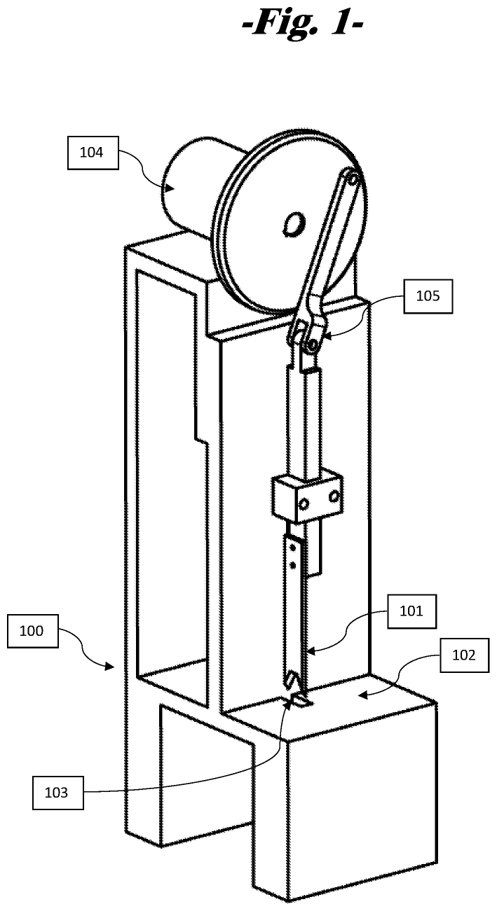

As shown in FIG. 1 the Facemask Dis-Assembly Tool 100 comprises of a punch 101, a base 102, an actuator 104 and actuation mechanism 105. The base 102 is a fixed member of the tool where as the punch 101 is a moving member. The base 102 has an opening 103 which corresponds to the size and position of the punch 101. The opening 103 is bigger than the punch so that it can accommodate the punch and the nose strip thickness. The punch 101 is shown in retracted position. The Punch 101 is driven in back-and-forth reciprocating motion by an actuator 104 through a mechanism 105.

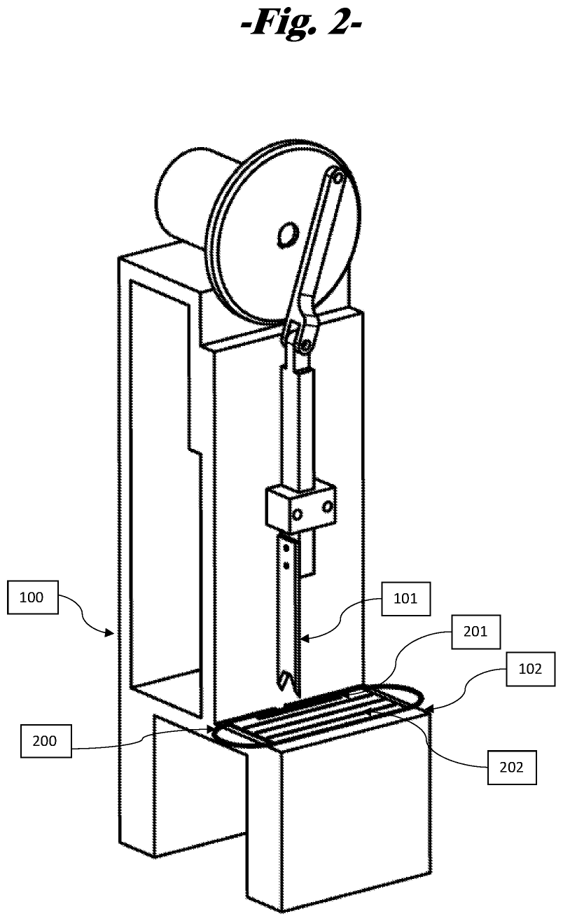

FIG. 2 shows a face mask 200 placed on the base 102 of the Facemask Dis-assembly Tool 100. The mask 200 is comprised of nose strip 201 and mask fabric 202. The mask 200 can be placed in the tool as a manual feed or an automatic feed. The mask is positioned in a way that the nose strip of the mask is placed on the opening 103.

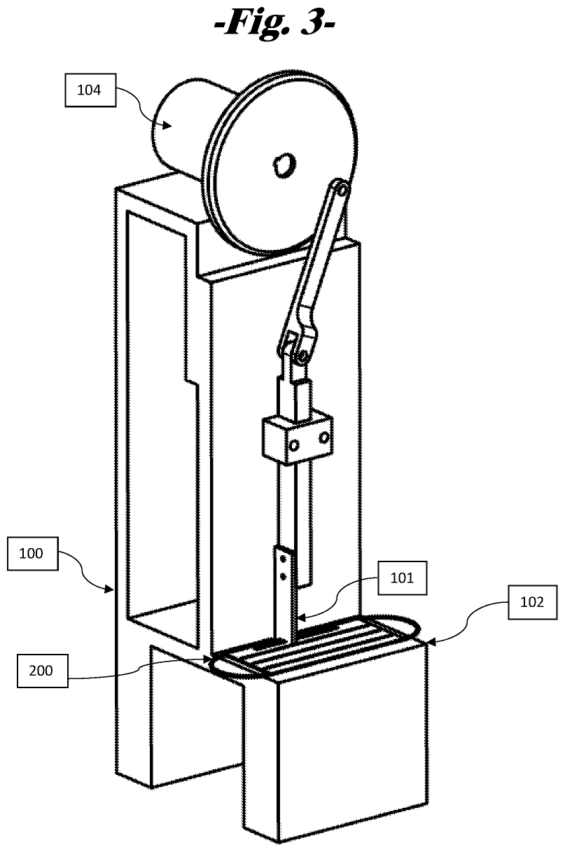

FIG. 3 shows the Facemask Dis-assembly Tool 100 in action. The punch 101 is shown in extended position. The actuator 104 drives the punch 101 towards the base 102. When the punch 101 advances towards the base 102 it cuts through the fabric of the mask 200. After cutting through the mask fabric, punch 101 interferes with the nose strip 201 of the mask 200.

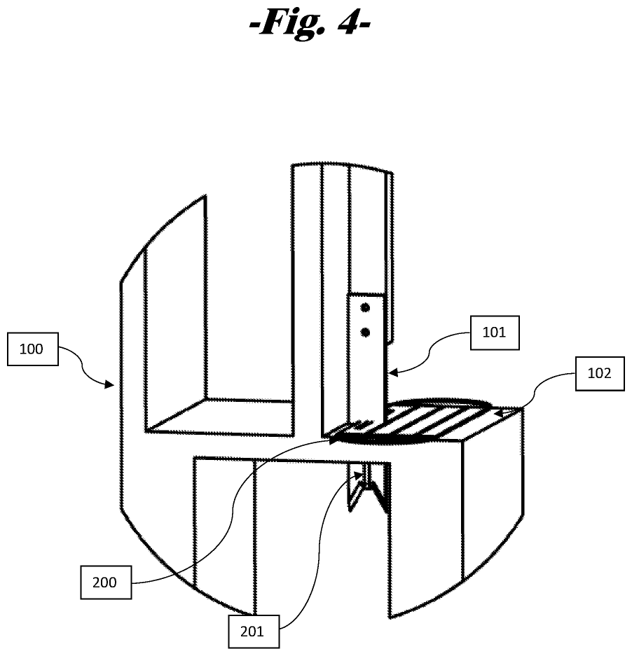

FIG. 4 shows the nose strip 201 being pulled out of the mask 200 as the punch 101 advances through the base 102 of the Facemask Dis-assembly Tool 100.

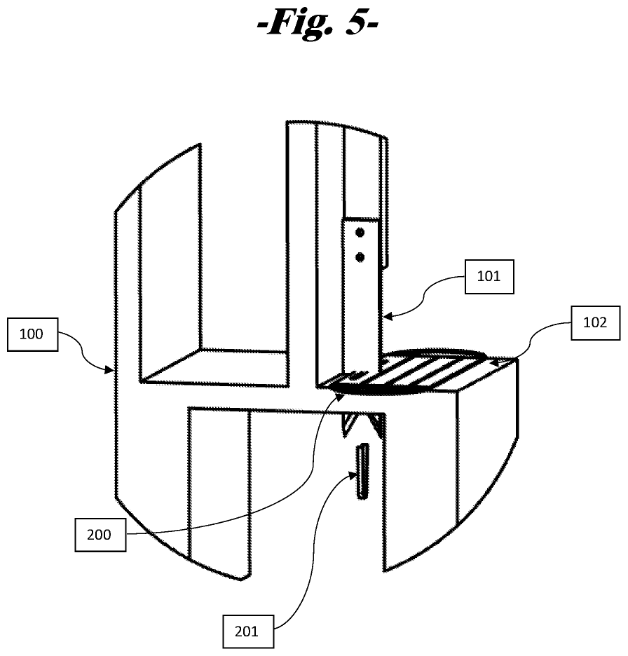

FIG. 5 shows the retracting of the punch 101 after full extension. When the punch 101 pushed the nose strip 201 through the base opening 103, the nose strip 201 then sprung open, making it bigger in size as compare to the opening 103. Since the nose strip 201 is now bigger than the opening 103, the nose strip 201 can not retract through the opening 103 when the punch 101 retracts to its home position. This makes the nose strip 201 free from the punch 101 and the base 102. The nose strip 201 now becomes free from the mask 200 and the tool 100. Nose strip 201 is then stored in a storage bin and the mask fabric 202 is stored in a separate storage bin.

What is claimed is:

1. A facemask dis-assembly tool that removes a nose-strip from a surgical facemask comprising:
a punch securely attached to a flat blade having at least two teeth on one end such that teeth are spaced apart and are pointing in same direction,
a horizontal platform having an opening bigger than the blade thickness such that the punch blade moves freely in the opening,
a mechanical arm with one end attached to the punch and other end free,
a mechanical drive attached to the mechanical arm.

2. The facemask dis-assembly tool of claim 1, where in a mechanical drive is an electric motor

3. The facemask dis-assembly tool of claim 2, where in a circular disc is attached to the motor such that motor shaft is concentric to the circular disc.

4. The facemask dis-assembly tool of claim 3, where in the circular disc has an anchoring feature at a radial distance from center of the disc

5. The facemask dis-assembly tool of claim 4, where in the free end of the mechanical arm is attached to the anchoring feature of the circular disc

6. The facemask dis-assembly tool of claim 5, where in the mechanical arm can pivot around the anchoring feature of the circular disc.

7. The facemask dis-assembly tool of claim 6, where in the punch is attached to the other end of the mechanical arm such that the punch can pivot around the mechanical arm at the attached end.

8. The facemask dis-assembly tool of claim 7, where in the punch is constrained to reciprocate vertically through the platform opening such that the punch blade rises above the platform and then drops through the platform opening as the motor rotates.

9. The facemask dis-assembly tool of claim 8, where in a facemask can be placed on the horizontal platform.

10. A method of nose-strip removal of from a surgical facemask comprising:
a facemask dis-assembly tool with a vertically reciprocating punch securely attached to a blade having at least two teeth on one,
a horizontal platform having an opening bigger than the blade thickness such that the punch blade reciprocates above and through the platform opening freely.

11. A method of claim 10, where in a facemask is placed on the horizontal platform such that nose-strip of a facemask is positioned on the opening while the blade is above the platform.

12. A method of claim 11, where in the blade progresses through the facemask into the platform opening.

13. A method of claim 12, where in the blade cuts the fabric of the facemask and nose-strip of facemask catches the space between the blade teeth.

14. A method of claim 13, where in blade progresses further through the platform and pulls the nose-strip out of the facemask

15. A method of claim 14, where in the nose-strip fully separates from the facemask and falls down due to gravity

16. A method of claim 15, where in the blade moves back up to go above the platform for subsequent cycle.
